(19) United States
(12) Patent Application Publication
(10) Pub. No.: US 2025/0065518 A1
(43) Pub. Date: Feb. 27, 2025

(54) CUTTING TOOL WITH BLADE POCKET AND METHODS OF MANUFACTURING

(71) Applicant: Klever Kutter LLC, Irvine, CA (US)

(72) Inventors: Kody Numedahl, Irvine, CA (US); Brad Ahrens, Irvine, CA (US)

(73) Assignee: Klever Kutter LLC, Irvine, CA (US)

(21) Appl. No.: 18/236,502

(22) Filed: Aug. 22, 2023

(51) Int. Cl. B26B 5/00

(52) U.S. Cl. CPC B26B 5/005

(57) ABSTRACT

Described herein is a blade assembly for use within a cutting tool comprising a blade body having a blade cutting edge and a blade attachment attached to the blade body. At least a portion of the blade cutting edge extends beyond the blade attachment between a first attachment edge and a second attachment edge of the blade attachment. The first attachment edge includes a flat region, a curved region, and a recess region connecting the flat region and the curved region, and the recess region is located adjacent to an intersection point of the curved region of the first attachment edge and the blade cutting edge.

### FIELD OF THE INVENTION

The present disclosure relates to a blade assembly for use within a cutting tool and methods of manufacturing. More specifically, the present disclosure relates to a blade assembly that comprises a blade body and a blade attachment with blade pocket, which can be used within a cutting tool.

### RELATED ART

Cutting tools, such as utility knife, can be used for many purposes, such as opening cardboard boxes, cutting sheet material, cutting web material, opening packages, etc. When using the utility knife to cut through the material, such as cardboard, the cardboard breaks apart and may create small fragments or debris. These fragments or debris will accumulate between the blade and the cardboard, which causes jamming and prevents the knife from slicing through the material.

Furthermore, when cutting through the cardboard, the utility knife is guided through the material, and the edge of the knife may block the movement of the cardboard and prevent the cardboard from moving along the cutting path, and therefore disrupt the cutting process and greatly affect the cutting performance.

Moreover, when using a cutting tool that has exterior holes on the blade handle to cut through the material, such as cardboard product, wood product, or food, etc., the fragments or debris of the material will accumulate in the exterior holes on the blade handle, and therefore make it difficult to maintain cleanliness.

Therefore, there is a need in the art for a cutting tool that is able to cut through materials without getting jammed by small debris or fragments. There is further a need in the art for cutting tools that do not have exterior holes on the blade handle, in order to prevent collection of fragments or debris in those holes. Embodiments of the present invention are intended to solve for these issues.

### SUMMARY OF THE INVENTION

The present disclosure relates to cutting tool with a blade assembly and methods of manufacturing.

In accordance with embodiments of the present disclosure, an exemplary blade assembly is provided. A blade assembly for use within a cutting tool comprises a blade body having a blade cutting edge and a blade attachment attached to the blade body. At least a portion of the blade cutting edge extends beyond the blade attachment between a first attachment edge and a second attachment edge of the blade attachment. The first attachment edge includes a flat region, a curved region, and a recess region connecting the flat region and the curved region, and the recess region is located adjacent to an intersection point of the curved region of the first attachment edge and the blade cutting edge.

In certain embodiments, the second attachment edge and the flat region of the first attachment edge define a cutting channel such that material being cut moves along the cutting channel, and the curved region of the first attachment edge is offset from the cutting channel.

In certain embodiments, the flat region of the first attachment edge defines a cutting plane that restricts a movement of the material being cut along the cutting channel.

In other embodiments, the recess region and the curved region of the first attachment edge are connected along a common plane.

In some embodiments, the curved region of the first attachment edge extends along an extending direction of the cutting channel.

In other embodiments, the blade assembly further comprises a handle adaptor configured to connect the blade assembly to a handle, wherein the handle adaptor is secured to the blade attachment.

In other embodiments, the handle adaptor comprises a handle securing mechanism that secures the handle adaptor to the handle.

In certain embodiments, the blade cutting edge forms an angle with respect to the flat region of the first attachment edge to encourage the material being cut to move toward the blade cutting edge.

In some embodiments, the blade cutting edge has a triangular shaped cross section.

In some embodiments, the blade body comprises a material selected from the group consisting of: carbon steel, heat treated metal, heat treated carbon steel and stainless steel.

In accordance with embodiments of the present disclosure, exemplary method of manufacturing blade assembly for use within a cutting tool are provided. A method of manufacturing blade assembly for use within a cutting tool comprises providing a blade body having a blade cutting edge, and forming a blade attachment attached to the blade body, at least a portion of the blade cutting edge extending beyond the blade attachment between a first attachment edge and a second attachment edge of the blade attachment. The first attachment edge includes a flat region, a curved region, and a recess region connecting the flat region and the curved region, and the recess region is located adjacent to an intersection point of the curved region of the first attachment edge and the blade cutting edge.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIGS. 1-6 illustrate an exemplary a blade assembly for use within a cutting tool according to an embodiment of the disclosure.

FIG. 7 is a flowchart illustrating an exemplary process for manufacturing the blade assembly of FIGS. 1-6.

FIGS. 8-10 illustrate another exemplary cutting tool according to an embodiment of the disclosure.

FIG. 11 is a flowchart illustrating an exemplary process for manufacturing the cutting tool of FIGS. 8-10.

### DETAILED DESCRIPTION OF THE INVENTION

Embodiments of the disclosure are described below with reference to the accompanying drawings, which depict embodiments of the disclosed blade assembly for use within a cutting tool and exemplary applications thereof. However, it is to be understood that applications of the disclosed blade assembly are not limited to those embodiments illustrated. Also, the disclosure is not limited to the depicted embodiments and details thereof, which are provided for purposes of illustration and not limitation.

The present disclosure relates to a blade assembly for use within a cutting tool and methods of manufacturing. The present disclosure addresses the shortcomings of conventional blade assembly and solves the challenges in the art by providing a blade assembly that, in certain embodiments, have a blade pocket.

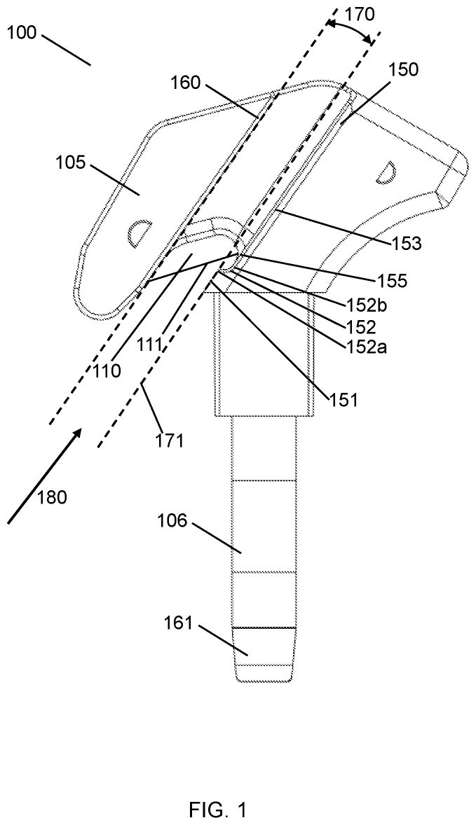

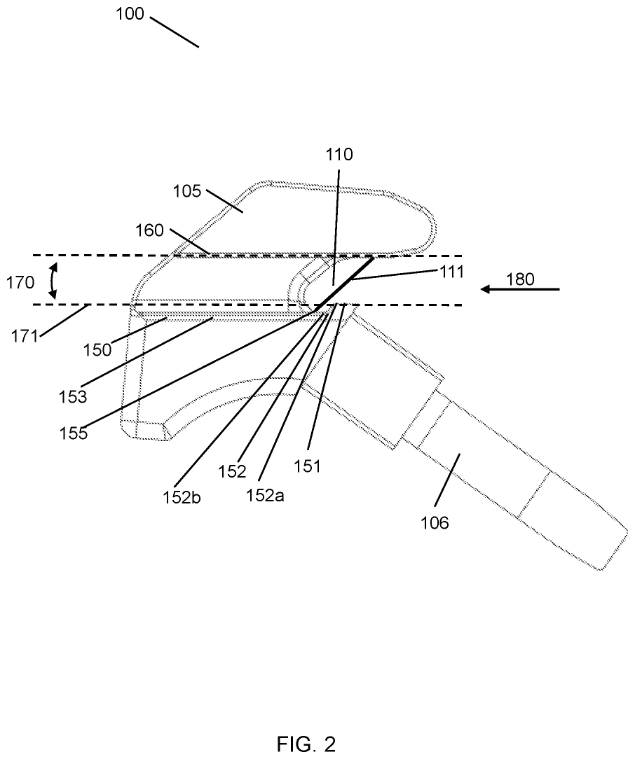

FIGS. 1-6 illustrate an exemplary blade assembly according to an embodiment of the disclosure. FIG. 1 shows a front side view of a blade assembly 100 and FIG. 2 shows a backside view of the blade assembly 100. The blade assembly 100 comprise a blade body 110, a blade attachment 105 attached to the blade body 110, and a handle adaptor 106. The blade body 110 may be formed from a relatively thin and substantially flat material. Examples of suitable material for use in the blade body 110 include stainless steel, heat treated carbon steel, ceramic, ceramic coated steel, Teflon coated material, etc. The blade body 110 has a blade cutting edge 111 and a top edge (not shown) opposite to the blade cutting edge 111. The blade cutting edge 111 may have a triangular shaped cross section. The top edge of the blade body 110 is located within the blade attachment 105. The blade attachment 105 may be made of a thermal plastic material or other suitable material. In certain embodiments, the blade attachment 105 may be molded around the blade body 110.

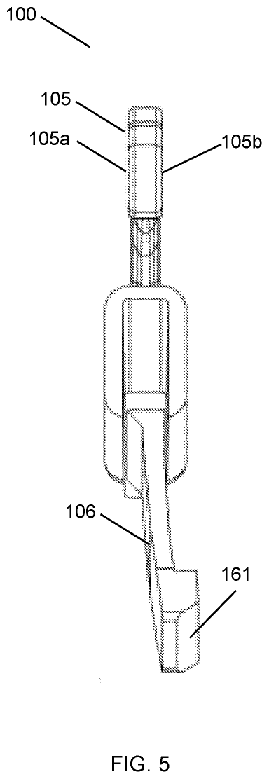

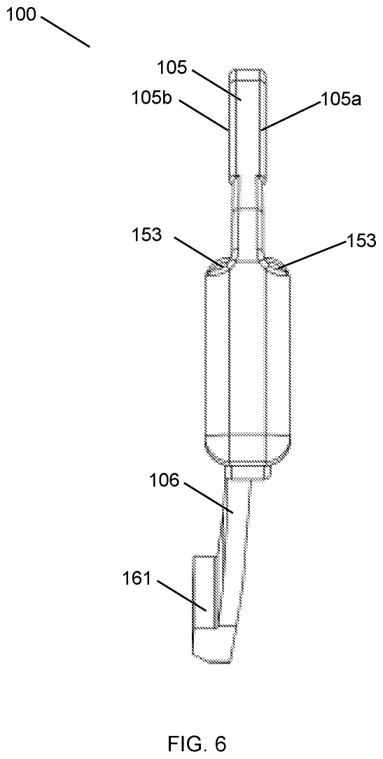

According to another embodiment, the blade body 110 may be inserted in the blade attachment 105 and therefore the blade body 110 is replaceable. FIGS. 5 and 6 illustrate a left side view and a right side view of the blade assembly 100, respectively. As shown in FIGS. 5 and 6, the blade attachment 105 may have a first half 105a and a second half 105b. The first half 105a and the second half 105b of the blade attachment 105 is connected to each other via connecting elements, for example, a hinge mechanism, snap fasteners, or other suitable connectors, such that the blade body 110 may be replaced if needed.

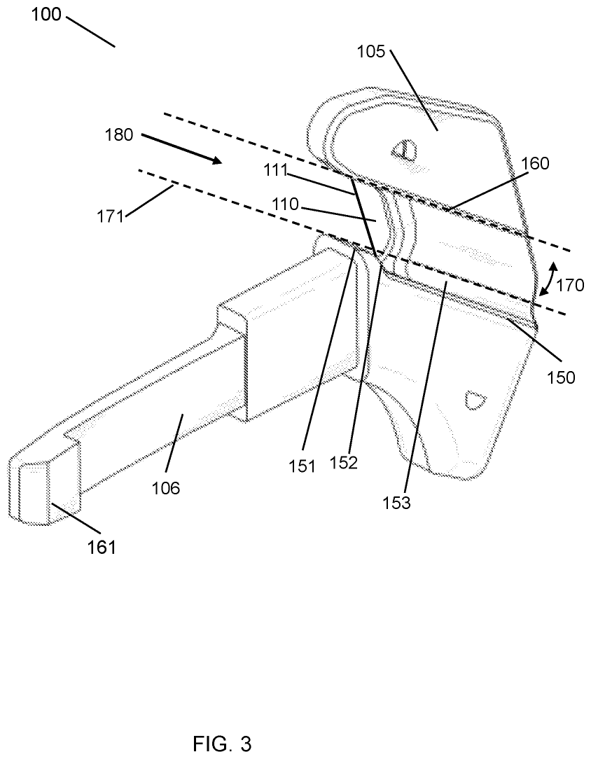

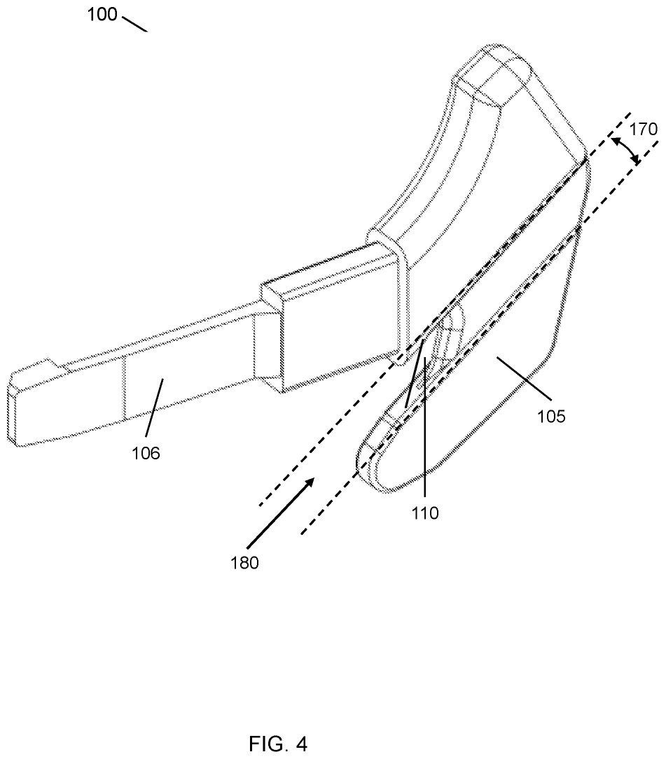

The handle adaptor 106 is secured to the blade attachment 105 and may be inserted in a handle (not shown) to connect the blade assembly 100 to the handle. FIG. 3 illustrates a perspective view of the front side of the blade assembly 100 and FIG. 4 illustrates a perspective view of the backside of the blade assembly 100. As shown in FIGS. 3 and 4, the handle adaptor 106 includes a handle securing mechanism 161 that may connect the handle adaptor 106 to the handle. For example, when the handle adaptor 106 is inserted in the handle, the handle securing mechanism 161 located at the bottom of the handle adaptor 106 can secure the blade assembly 100 to the corresponding handle.

As shown in FIG. 1, at least a portion of the blade cutting edge 111 of the blade body 110 extends beyond the blade attachment 105 between a first attachment edge 150 and a second attachment edge 160 of the blade attachment 105. The first attachment edge 150 includes a flat region 151, a recess region 152, and a curved region 153. The recess region 152 connects the flat region 151 and the curved region 153.

The recess region 152 is a concave region located adjacent to an intersection point 155 of the curved region 153 and the blade cutting edge 111. The recess region 152 extends from a first edge 152a to a second edge 152b. The recess region 152 is connected to the flat region 151 at the first edge 152a, and connected to the curved region 153 at the second edge 152b.

As shown in FIG. 1, the recess region 152 defines a blade pocket on the first attachment edge 150, and the recess region 152, i.e., the blade pocket, is located adjacent to an intersection point 155 of the curved region 153 and the blade cutting edge 111. In other words, the recess region 152, i.e., the blade pocket, is located at the corner between the blade cutting edge 111 and the curved region 153. Accordingly, when using the blade assembly 100 with the blade pocket to cut through the cardboard, the fragments or debris of the cardboard created during the cutting process will not accumulate at the corner between the blade cutting edge 111 and the first attachment edge 150, and therefore will avoid jamming during the cutting process.

When the blade assembly 100 is used to cut the cardboard, the cardboard contacts and moves toward the blade cutting edge 111 along the direction of arrow 180 shown in FIG. 1, and the movement of the cardboard is restricted by the flat region 151, which defines a cutting plane 171. A cutting channel 170 is defined between the flat region 151 of the first attachment edge 150 and the second attachment edge 160. The cutting channel 170 extends along the direction of arrow 180. The width of the cutting channel 170 can be modified based on the dimensions or size of the blade assembly. For example, in one embodiment, the width of the cutting channel 170 may be approximately 0.20-1.2 inches. One of ordinary skill in the art would appreciate that the width of the cutting channel could be increased or decreased in certain embodiments, and embodiments of the present invention are contemplated for use with a cutting channel of any width. Varying widths may be warranted for various utility needs, such as cutting thicker or thinner materials, or where the need to cut a specific size of material is needed.

The curved region 153 extends along the direction of arrow 180 shown in FIG. 1, which is the same extending direction of the cutting channel 170. As shown in FIG. 6 that illustrates the right side view of the blade assembly 100, the curved region 153 curves inward and has a concave appearance. The recess region 152 and the curved region 153 are smoothly connected along a common plane at the second edge 152b of the recess region 152, and therefore form a continuous transition.

As shown in FIG. 1, the recess region 152 is a concave region that is connected to the flat region 151 at the first edge 152a and connected to the curved region 153 along a common plane at the second edge 152b. Accordingly, the curved region 153 is offset from the flat region 151 that defines the cutting plane 171, and therefore, the curved region 153 is offset from the cutting channel 170, which is defined between the flat region 151 and the second attachment edge 160.

When using the utility knife to cut through the cardboard, the cardboard moves along the direction of arrow 180 in the cutting channel 170. Since the curved region 153 is out of the cutting channel 170, the movement of the cardboard will not be blocked by the edge of the knife, and therefore will not disrupt the cutting process.

Furthermore, for the utility knife used to cut materials, the size of the curved region relates to the strength of the blade assembly. For example, the blade assembly with a larger radius curved region has better product strength than that with a smaller radius curved region. In a conventional blade assembly without the blade pocket, the curved region is within the cutting channel, such that a large radius curved region will block the movement of the cardboard during cutting process and affect cutting performance. However, as discussed above, in the blade assembly of the invention, the blade pocket offsets the curved region from the cutting channel, such that the curved region of the blade assembly may have a large radius curved region, which improves the strength of the blade assembly.

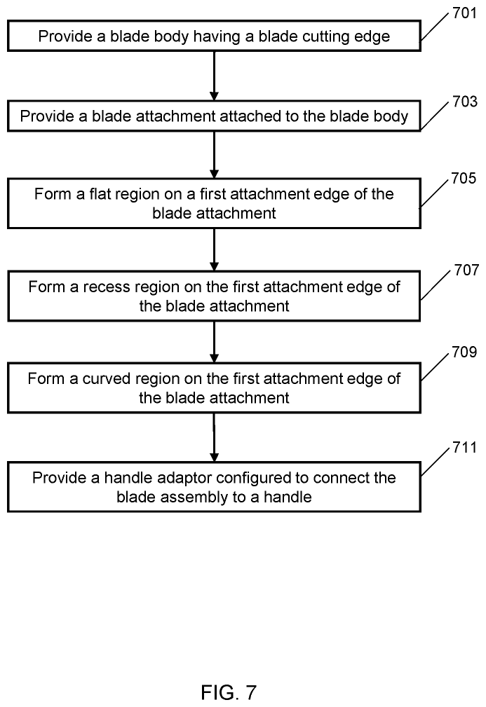

FIG. 7 is a flowchart illustrating an exemplary process for manufacturing the blade assembly of FIGS. 1-6. At step 701, a blade body having a blade cutting edge and a top edge opposite to the blade cutting edge is provided. The blade cutting edge may have a triangular shaped cross section. At step 703, a blade attachment is provided such that at least a portion of the blade cutting edge of the blade body extends beyond the blade attachment between a first attachment edge and a second attachment edge of the blade attachment. The blade attachment may be molded around the blade body. Alternatively, the blade attachment may have a first half and a second half connected to each other via connecting elements, and the blade body may be inserted in or removed from the blade attachment.

At step 705, a flat region is formed on the first attachment edge of the blade attachment. The flat region defines a cutting plane. The movement of the materials being cut, for example, cardboard, is restricted by the flat region. A cutting channel is defined between the flat region of the first attachment edge and the second attachment edge.

At step 707, a recess region is formed on the first attachment edge of the blade attachment, and at step 709, a curved region is formed on the first attachment edge of the blade attachment. The recess region connect the flat region and the curved region. The recess region, which defines a blade pocket, is a concave region located adjacent to an intersection point of the curved region and the blade cutting edge. Accordingly, when using the blade assembly with the blade pocket to cut through the cardboard, the fragments or debris of the cardboard created during the cutting process will not accumulate at the corner between the blade cutting edge and the first attachment edge, and therefore will avoid jamming during the cutting process.

As the recess region and the curved region are smoothly connected along a common plane, the curved region is offset from the flat region that defines the cutting plane. Accordingly, the curved region is offset from the cutting channel. When using the utility knife to cut through the cardboard, since the curved region is out of the cutting channel, the movement of the cardboard will not be blocked by the curved region on the edge of the knife, and therefore will not disrupt the cutting process.

In step 711, a handle adaptor is provided to connect the blade assembly to a handle. The handle adaptor is secured to the blade attachment. The handle adaptor includes a handle securing mechanism that may connect the handle adaptor to the handle.

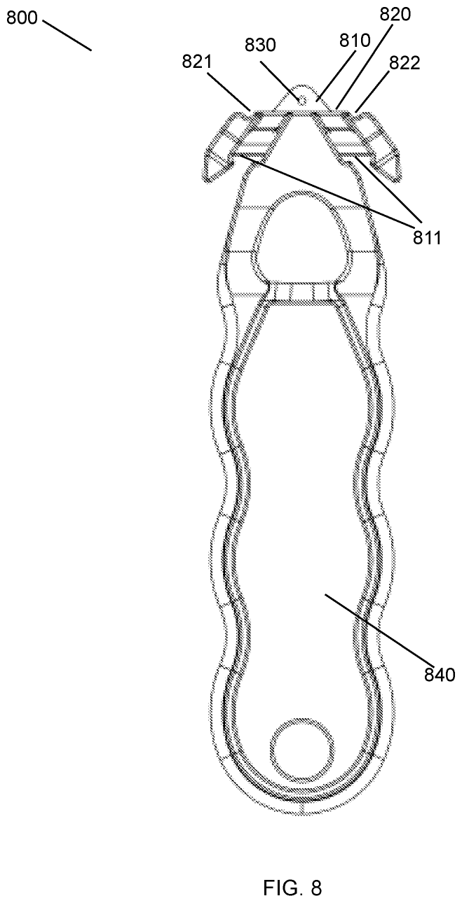

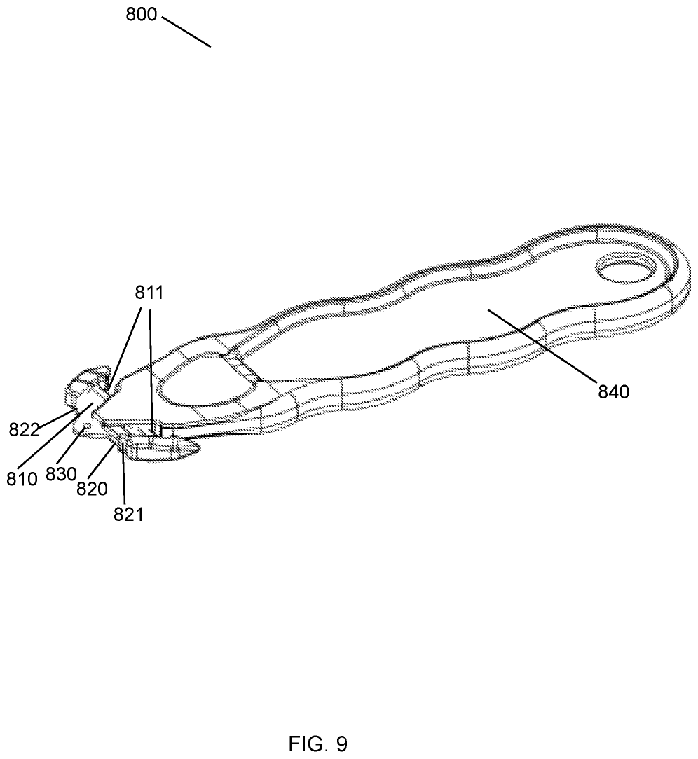

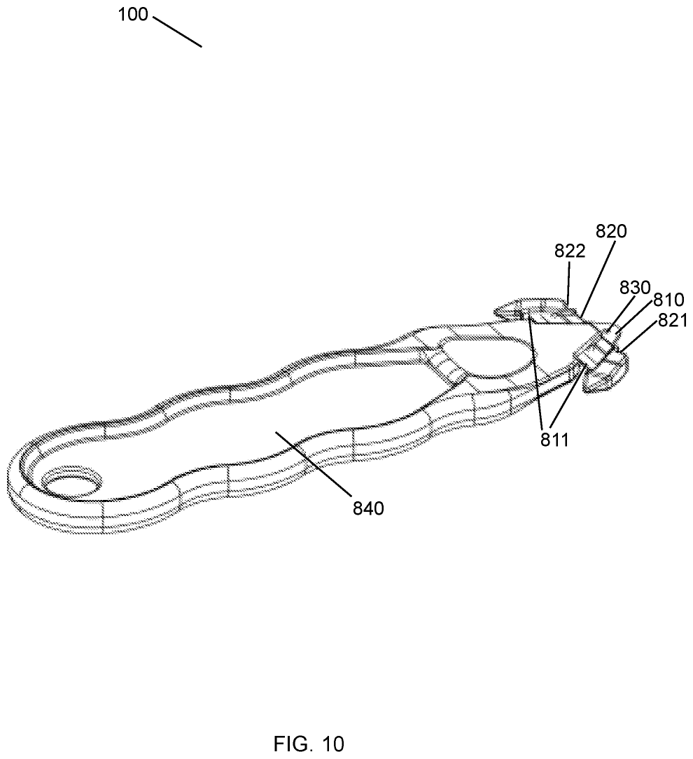

FIGS. 8-10 illustrate another exemplary cutting tool according to an embodiment of the disclosure. FIG. 8 shows a front side view of a cutting tool 800, and FIGS. 9 and 10 show a perspective view of the front side and a perspective view of the backside of the cutting tool 800, respectively. The cutting tool 800 comprise a blade body 810 and a blade handle 840 attached to the blade body 810. The blade body 810 may be formed from a relatively thin and substantially flat material. Examples of suitable material for use in the blade body 810 include stainless steel, heat treated carbon steel, ceramic, ceramic coated steel, Teflon coated material, etc. The blade handle 840 may be made of a thermal plastic material or other suitable material.

In certain embodiments, the blade handle 840 may be molded around the blade body 810. The blade body 810 has a blade cutting edge 811 and an upper edge opposite to the blade cutting edge 811. As shown in FIG. 8, at least one portion of the blade cutting edge 811 extends beyond the blade handle 840. A portion of the blade body 810 where a pinhole 830 is located also extends beyond the blade handle 840. There are two recess regions 821 and 822 on edge 820 of the blade handle 840. The recess region 821 may be located on the left side of the pinhole 830 and the recess region 822 may be located on the right side of the pinhole 830. The upper edge of the blade body 810, which is positioned within the blade handle 840, may be in contact with the recess regions 821 and 822 of the blade handle 840. For example, The upper edge of the blade body 810 may be tangent to both of the recess regions 821 and 822.

Accordingly, the cutting tool shown in FIGS. 8-10 does not have exterior holes on the blade handle 840. Therefore, when using the cutting tool shown in FIGS. 8-10 to cut through the material, such as cardboard product, wood product, or food, etc., the fragments or debris of the material will not accumulate on the blade handle, and therefore simplifies the cleaning process for the cutting tool and make it easier to maintain cleanliness.

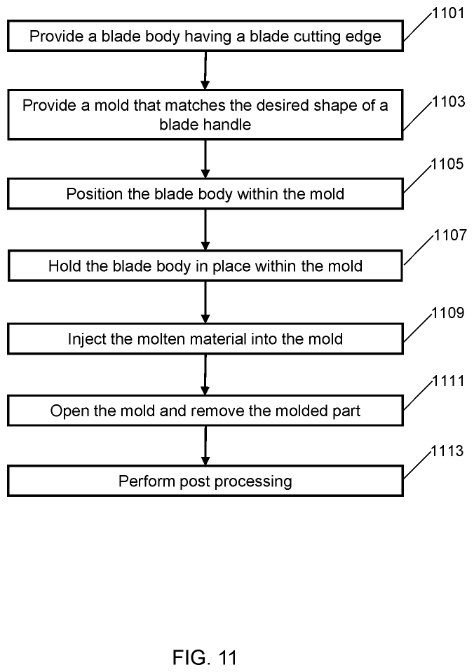

FIG. 11 is a flowchart illustrating an exemplary process for manufacturing the cutting tool of FIGS. 8-10. At step 1101, a blade body that has a blade cutting edge and an upper edge opposite to the blade cutting edge is provided. The blade cutting edge may have a triangular shaped cross section. At step 1103, a mold of the blade handle is provided. The mold may have a cavity that matches the desired shape of the blade handle. The mold may be made of metal or other suitable materials.

At step 1105, the blade body is positioned within the mold, and a portion of the blade body where a pinhole is located is outside the mold. At step 1107, a first pin is positioned to go through the pinhole outside the mold. A second pin is provided to contact with the upper edge of the blade body on one side of the pinhole, and similarly, a third pin is provided to contact with the upper edge of the blade body on the other side of the pinhole. For example, the second pin and the third pin may be positioned such that the upper edge of the blade body is tangent to both of the second pin and the third pin. Accordingly, after the mold is closed, these three pins may firmly hold the blade body in place within the mold cavity, which prevent the blade body from rotating or moving during the molding process.

At step 1109, molten material, such as thermal plastic, rubber, or other suitable material, is injected into the mold cavity. The material fills the space around the blade body and adheres completely to the blade body. After the injected material is solidified, at step 1111, the mold is opened and the molded part, i.e., the blade handle is removed from the mold.

The molded blade handle may require further treatment before being used, so at step 1113, the molded blade handle is treated with post processing, such as polishing, surface finish, heat and humidity treatment, or other treatments to achieve the desired appearance and functionality.

Accordingly, the cutting tool with the molded blade handle has two recess regions on the edge of the blade handle, but does not have exterior holes on the blade handle, such that the fragments or debris of the material being cut will not accumulate on the blade handle, and therefore simplifies the cleaning process for the cutting tool and make it easier to maintain cleanliness.

In some embodiments, the shape of the recess region on the edge of the blade handle may be semi-circle, square, triangle, etc. Accordingly, the pins that hold the blade body in place within the mold cavity may also have the shape of circle, square, triangle, etc.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

The foregoing description of the specific embodiments of the subject matter disclosed herein has been presented for purposes of illustration and description and is not intended to limit the scope of the subject matter set forth herein. It is fully contemplated that other various embodiments, modifications and applications will become apparent to those of ordinary skill in the art from the foregoing description and accompanying drawings. Thus, such other embodiments, modifications, and applications are intended to fall within the scope of the following appended claims. Further, those of ordinary skill in the art will appreciate that the embodiments, modifications, and applications that have been described herein are in the context of particular environment, and the subject matter set forth herein is not limited thereto, but can be beneficially applied in any number of other manners, environments and purposes. Accordingly, the claims set forth below should be construed in view of the full breadth and spirit of the novel features and techniques as disclosed herein.

1. A cutting tool with a blade assembly, comprising:
a blade body having a blade cutting edge; and
a blade attachment attached to the blade body, at least a portion of the blade cutting edge extending beyond the blade attachment between a first attachment edge and a second attachment edge of the blade attachment,
wherein the first attachment edge includes a flat region, a curved region, and a recess region connecting the flat region and the curved region, and the recess region is located adjacent to an intersection point of the curved region of the first attachment edge and the blade cutting edge.

2. The blade assembly of claim 1, wherein the second attachment edge and the flat region of the first attachment edge define a cutting channel such that material being cut moves along the cutting channel, and the curved region of the first attachment edge is offset from the cutting channel.

3. The blade assembly of claim 1, wherein the flat region of the first attachment edge defines a cutting plane that restricts a movement of the material being cut along the cutting channel.

4. The blade assembly of claim 1, wherein the recess region and the curved region of the first attachment edge are connected along a common plane.

5. The blade assembly of claim 1, wherein the curved region of the first attachment edge extends along an extending direction of the cutting channel.

6. The blade assembly of claim 1, further comprising:
a handle adaptor configured to connect the blade assembly to a handle, wherein the handle adaptor is secured to the blade attachment.

7. The blade assembly of claim 6, wherein the handle adaptor comprises a handle securing mechanism that secures the handle adaptor to the handle.

8. The blade assembly of claim 1, wherein the blade cutting edge forms an angle with respect to the flat region of the first attachment edge to encourage the material being cut to move toward the blade cutting edge.

9. The blade assembly of claim 1, wherein the blade cutting edge has a triangular shaped cross section.

10. The blade assembly of claim 1, wherein the blade body comprises a material selected from the group consisting of: carbon steel, heat treated metal, heat treated carbon steel and stainless steel.

11. A method of manufacturing blade assembly for use within a cutting tool, the method comprising;
providing a blade body having a blade cutting edge; and
forming a blade attachment attached to the blade body, at least a portion of the blade cutting edge extending beyond the blade attachment between a first attachment edge and a second attachment edge of the blade attachment;
wherein the first attachment edge includes a flat region, a curved region, and a recess region connecting the flat region and the curved region, and the recess region is located adjacent to an intersection point of the curved region of the first attachment edge and the blade cutting edge.

12. The method of claim 11, wherein the second attachment edge and the flat region of the first attachment edge define a cutting channel such that material being cut moves along the cutting channel, and the curved region of the first attachment edge is offset from the cutting channel.

13. The method of claim 11, wherein the flat region of the first attachment edge defines a cutting plane that restricts a movement of the material being cut along the cutting channel.

14. The method of claim 11, wherein the recess region and the curved region of the first attachment edge are connected along a common plane.

15. The method of claim 11, wherein the curved region of the first attachment edge extends along an extending direction of the cutting channel.

16. The method of claim 11, further comprising:
forming a handle adaptor configured to connect the blade assembly to a handle, wherein the handle adaptor is secured to the blade attachment.

17. The method of claim 16, wherein the handle adaptor comprises a handle securing mechanism that secures the handle adaptor to the handle.

18. The method of claim 11, wherein the blade cutting edge forms an angle with respect to the flat region of the first attachment edge to encourage the material being cut to move toward the blade cutting edge.

19. The method of claim 11, wherein the blade cutting edge has a triangular shaped cross section.

20. The method as in claim 11, wherein the blade body comprises a material selected from the group consisting of: carbon steel, heat treated metal, heat treated carbon steel and stainless steel.
